(19) United States
(12) Patent Application Publication
(10) Pub. No.: US 2022/0320746 A1
(43) Pub. Date: Oct. 6, 2022

(54) ANTENNA APPARATUS

(71) Applicant: NOKIA SOULTIONS AND NETWORKS OY, Espoo (FI)

(72) Inventor: Juha Samuel HALLIVUORI, Tampere (FI)

(73) Assignee: NOKIA SOULTIONS AND NETWOEK OY, Espoo (FI)

(21) Appl. No.: 17/708,231

(22) Filed: Mar. 30, 2022

(30) Foreign Application Priority Data
Mar. 30, 2021 (FI) 20215376

(51) Int. Cl. H01Q 19/19; H01Q 15/16; H01Q 21/06

(52) U.S. Cl. CPC H01Q 19/193; H01Q 15/16; H01Q 21/065

(57) ABSTRACT

Example embodiments relate to antenna apparatus comprising a feed reflector. According to various, but not necessarily all, embodiments of the invention there is provided an apparatus, comprising: an antenna feed array; a main antenna reflector or lens; and a feed reflector; wherein the feed reflector comprises a concave reflective surface configured to reflect radio-frequency radiation from the antenna feed array towards the main antenna reflector or lens and dimensioned to adjust radio-frequency radiation transmittable from the antenna feed array to the main reflector or lens via the feed reflector by narrowing the spread of the radio-frequency radiation reflected by the feed reflector towards the main antenna reflector or lens. Example embodiments recognise that it is possible to improve gain achieved by antenna apparatus if a properly configured secondary reflector is provided close to a feed or feed array, to modify a radiation pattern which is fed to the main reflector.

### CROSS-REFERENCE TO RELATED APPLICATIONS

This application claims priority to Finnish Patent Application No. 20215376 filed Mar. 30, 2021, the entire contents of which is incorporated herein by reference.

### TECHNOLOGICAL FIELD

Various example embodiments relate to antenna apparatus comprising a feed reflector.

### BACKGROUND

Wireless communication systems are known. Typically users of such networks require access to high-quality services at any time and location and hence create substantial traffic. Wireless communication networks are adapting to provide sufficient capacity and satisfactory data rates. One possible adaptation comprises increasing available frequency bandwidth, for example, by using regions of the electromagnetic spectrum which may not have typically been used for cellular radio communication. Such regions include, for example, a “Super High Frequency” SHF region (3-10 GHz), 5G-New Radio bands and millimetre-wave (mm-wave) frequencies.

Another possible adaptation comprises providing internet access to a location using wireless mobile network technology rather than fixed lines, typically known as a Fixed Wireless Access (FWA) approach. FWA offerings can enable establishment of a cost-effective broadband service, even in locations which do not have access to fixed line broadband. Typically FWA requires minimal engineering work at a user location, a standard implementation requiring self-installation of user or customer premise equipment (CPE).

Providing a practical deployment which can accommodate adaptations such as increased frequency bandwidth and limitations associated with fixed wireless access points presents various challenges. It is desired to address some of those challenges.

### BRIEF SUMMARY

The scope of protection sought for various embodiments of the invention is set out by the independent claims. The [embodiments/examples] and features, if any, described in this specification that do not fall under the scope of the independent claims are to be interpreted as examples useful for understanding various embodiments of the invention.

According to various, but not necessarily all, embodiments of the invention there is provided an apparatus, comprising: an antenna feed array; a main antenna reflector or lens; and a feed reflector; wherein the feed reflector comprises a concave reflective surface configured to reflect radio-frequency radiation from the antenna feed array towards the main antenna reflector or lens and dimensioned to adjust radio-frequency radiation transmittable from the antenna feed array to the main reflector or lens via the feed reflector by narrowing the spread of the radio-frequency radiation reflected by the feed reflector towards the main antenna reflector or lens.

The feed reflector may have a curvature greater than the main antenna reflector or lens.

The feed reflector may be located closer to the antenna feed array than the main antenna reflector or lens.

The feed reflector may comprise a parabolic reflector.

The antenna feed array may be located at, or substantially at, the focal point of the parabolic feed reflector.

The main antenna reflector may comprise a parabolic reflector.

The antenna feed array may be located at, or substantially at, the focal point of the main parabolic reflector.

The feed reflector and main reflector may have a common main radiation directional axis.

The feed reflector and main reflector may be located on diametrically opposed sides of the antenna feed array.

The antenna feed array may be located between the feed reflector and main reflector.

The main reflector may be located, relative to the antenna feed array, in a direction of a main lobe of a radiation pattern generatable by the antenna feed array.

The main reflector may be configured to reflect the main lobe of a radiation pattern generatable by the antenna feed array.

The feed reflector may be located, relative to the antenna feed array, in a direction opposite to a direction of a main lobe of a radiation pattern generatable by the antenna feed array.

The feed reflector may be configured to reflect a back lobe of a radiation pattern generatable by the antenna feed array towards the main reflector.

The feed reflector may be configured to reflect a side lobe of a radiation pattern generatable by the antenna feed array towards the main reflector.

The apparatus may comprise a feed support structure configured to support the antenna feed array in position relative to the main reflector or lens and wherein the feed reflector forms part of the feed support structure.

The feed reflector may be integrally formed as part of the feed support structure.

The antenna feed array may comprise a longitudinal array formed from a plurality of patch antenna feed elements.

The antenna feed array may comprise a 1×4 longitudinal array formed from a plurality of patch antenna feed elements.

The apparatus components may be dimensioned to support radio-frequency radiation which comprises millimetre wave radiation.

According to various, but not necessarily all, embodiments of the invention there is provided a method, comprising: providing an antenna feed array; a main antenna reflector or lens; and a feed reflector; configuring a concave reflective surface of the feed reflector to reflect radio-frequency radiation from the antenna feed array towards the main antenna reflector or lens the concave reflective surface being dimensioned to adjust radio-frequency radiation transmittable from the antenna feed array to the main reflector or lens via the feed reflector by narrowing the spread of the radio-frequency radiation reflected by the feed reflector towards the main antenna reflector or lens.

According to various, but not necessarily all, embodiments of the invention there is provided an electronic device comprising the apparatus described above.

The electronic device may comprise a fixed wireless access base station for use in a millimetre wave radio communication network.

The electronic device may comprise an electronic radio frequency (RF) device. Such electronic RF devices may be any one of: a base station, a fixed wireless access device, a customer premise equipment, an access node, a fixed radio communications device or similar.

Further particular and preferred aspects are set out in the accompanying independent and dependent claims. Features of the dependent claims may be combined with features of the independent claims as appropriate, and in combinations other than those explicitly set out in the claims.

Where an apparatus feature is described as being operable to provide a function, it will be appreciated that this includes an apparatus feature which provides that function or which is adapted or configured to provide that function.

### BRIEF DESCRIPTION

Some example embodiments will now be described with reference to the accompanying drawings in which:

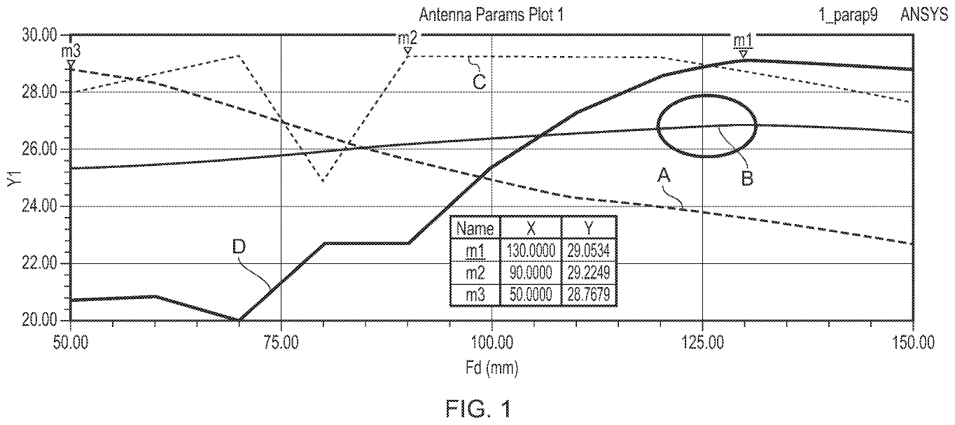

FIG. 1 is a plot illustrating gain which can be achieved in antenna implementations comprising a feed and a parabolic main reflector;

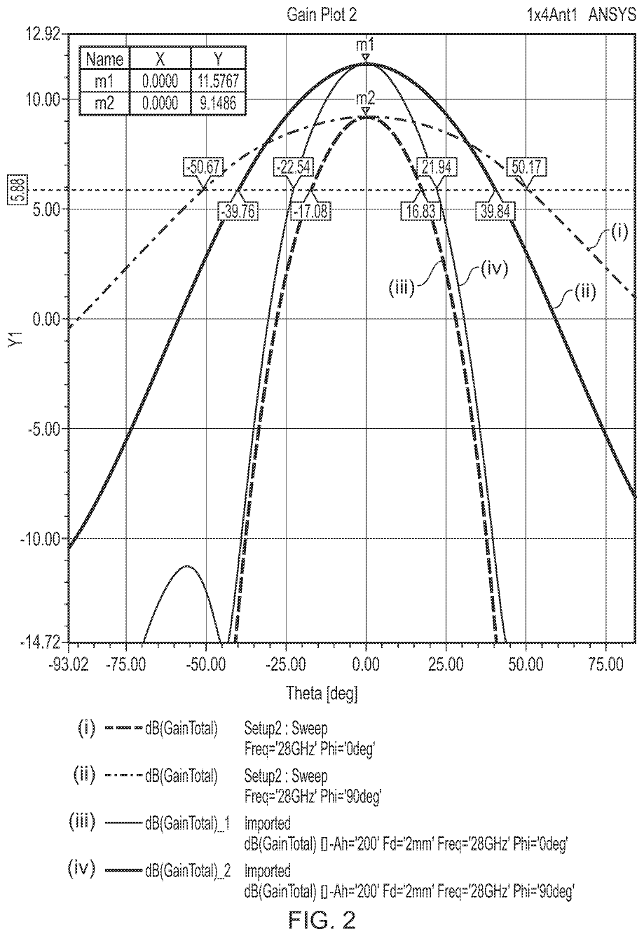

FIG. 2 is a plot illustrating energy in a radiation pattern emanating from a 1×4 feed array without a dedicated feed reflector and with a dedicated feed reflector according to one example embodiment;

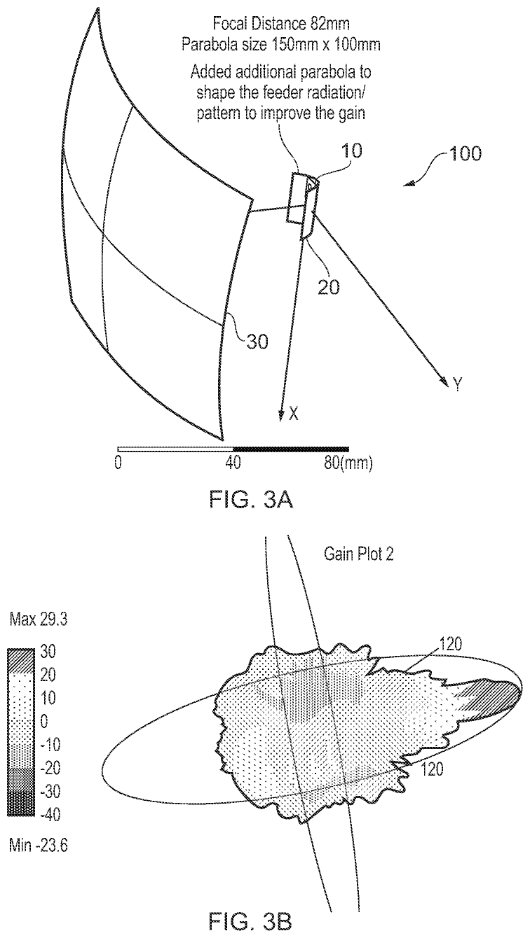

FIG. 3A illustrates schematically main components of an antenna apparatus including an arrangement according to one example embodiment;

FIG. 3B is 3-dimensional plot of gain achieved by an antenna apparatus such as that shown in FIG. 3A;

FIG. 3C is a plot of the horizontal and vertical gain achieved by an antenna apparatus such as that shown in FIG. 3A;

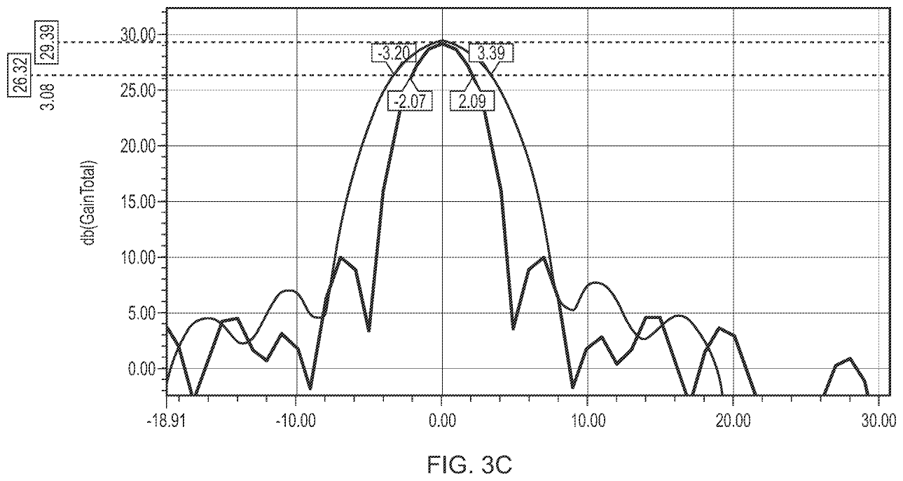

FIG. 4A illustrates some main components housed in and around a feed array support structure;

FIG. 4B is a plot of signal gain from an arrangement such as that shown in FIG. 4A;

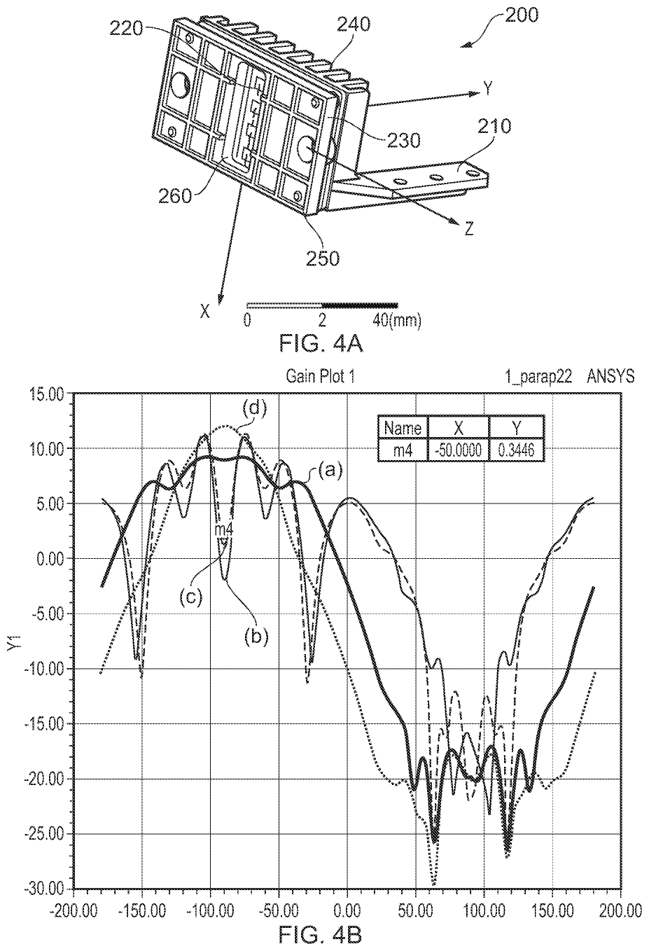

FIG. 5 illustrates some main components housed in and around a feed array support structure including a feed reflector according to one possible example embodiment;

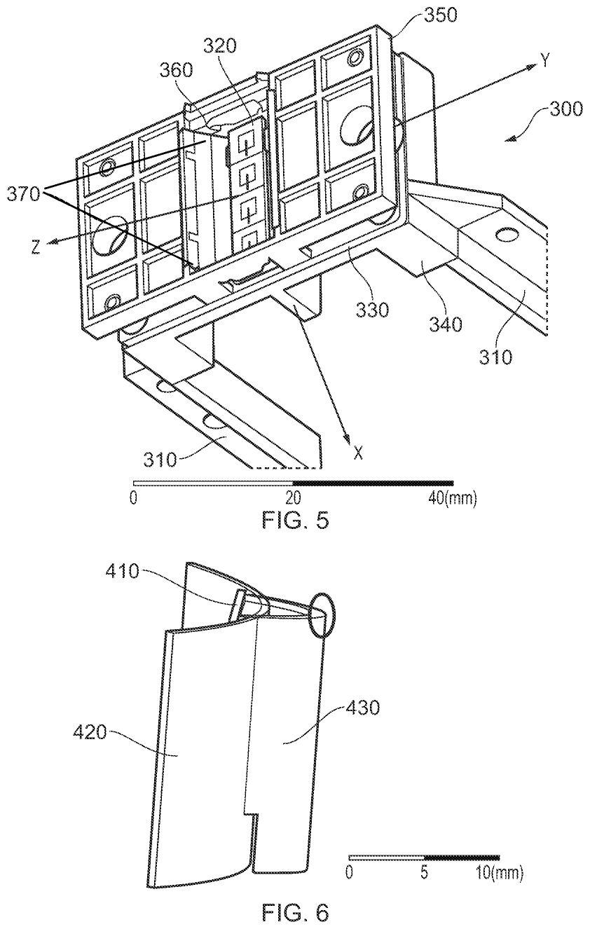

FIG. 6 illustrates some components of a feed array support including a feed reflector according to one example embodiment; and

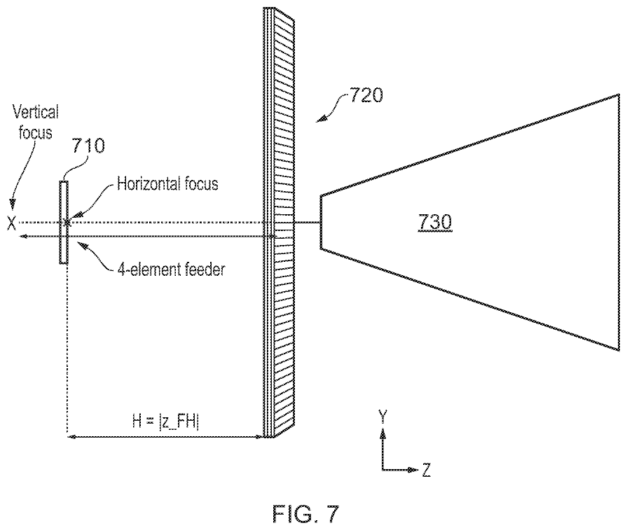

FIG. 7 illustrates some components of an antenna device according to one possible alternative example embodiment.

### DETAILED DESCRIPTION

Before discussing the example embodiments in any more detail, first an overview will be provided. As described above, increasing demand on wireless communication networks has led to adaptation and development, including consideration of traditionally unused portions of radio spectrum to support communication, and the provision of fixed wireless access points.

Provision of a fixed wireless access point as a network access node may sit between the typical hardware components manufactured for traditional wireless network nodes such as user equipment and large base stations. In particular, FWA products benefit if implemented with antenna apparatus, for example, array antennas, optimized for the particular requirements of a FWA deployment. In an ideal FWA deployment, an access point may be such that it has a fixed position at a location, provide users with high power and gain, yet not be too large or cumbersome and or too expensive to manufacture or maintain. Current antenna apparatus component manufacturers can provide optimised antennas and arrays, including those to operate in mmW 5G networks, which are suited to use in mobile handsets or large base stations. Mobile handset antenna deployments are typically subject to size and low power restrictions. Base station deployments can be large, expensive and operate at high power. A FWA base station antenna requirement sits between the requirements of those typical deployments: requiring high gain, with relatively low size and low cost.

A small antenna array structure, for example, a 1×4 patch array as might be used in a mobile handset will typically have a reasonable scanning capability in at least one direction and can therefore provide a region of network coverage in a FWA deployment. Such a small array may also be suited to a FWA deployment in terms of size and cost. However, straight reuse of such a mobile phone antenna array may suffer from disadvantages in relation to power and gain levels which can be provided. Namely, the power and gain level which can support effective operation of a mobile handset are inadequate when used to provide a FWA base station.

On the other hand, base station antenna array structures capable of supporting a required power level for a FWA base station take the form of arrays of 16, 32 or 64 antenna patches. Those antenna arrays can provide power levels 42 dBm, 47 dB and 52 dBm respectively, but come with size and cost disadvantages in a FWA deployment. A standard base station can support the size requirements of such arrays and the cost of such modules (ranging, for example, from $35 to $140), where a smaller local use base station, such as a FWA base station, may not.

Example embodiments recognise that it may be possible to configure a small antenna array such as those which might be used in a mobile device to provide coverage with sufficient gain to support operation of a FWA base station. In one example embodiment, which may be suited to use in a FWA base station, a small antenna array may be arranged with an additional feed reflector configured to adapt a signal being transmitted from a feed array to a main antenna reflector. Provision of a feed reflector in accordance with example embodiments may enhance operation of the antenna and improve antenna gain without significantly impacting overall device cost. In particular, example embodiments may provide an antenna array for a FWA deployment, the antenna apparatus comprising a main reflector and a secondary feed array reflector. The feed array reflector may be provided close to the feed array to modify or adapt the radiation which is incident upon the main reflector. The adaptation of the radiation pattern occurs in close proximity to the feed array, prior to incidence of the radiation pattern upon the main reflector. Such a configuration can support improved or optimised performance, particularly in relation to achievable gain, in the antenna apparatus for a FWA deployment by, for example, ensuring a greater proportion of energy radiated from the feed array is transferred to the main reflector and onwards.

In some example embodiments, one or both of the secondary feed reflector and main reflector may be parabolic. In some example embodiments, the feed array may be located at the focal point of one or both of the secondary feed reflector and main reflector. In some example embodiments, the secondary feed reflector may have a smaller focal distance, and therefore greater curvature, than the main reflector. In general, example embodiments seek to provide an antenna device of minimal complexity and expense, which can support gain at levels suited to a FWA base station deployment.

Example embodiments may have particular application in relation to millimetre wave communication FWA base station deployments. One identified application for millimetre wave communication networks is that of provision of an alternative to a traditional wired or optical broadband connection, in other words a FWA base station deployment. That is to say, it is possible that millimetre wave 5G deployments can be used to provide one or more cells at a customer premises which supports very high and/or very reliable data transmission between one or more base stations and users within a region of coverage provided or supported by such a base station. It will be appreciated that when providing a region of coverage or cell of coverage, a base station may be required to provide a cell which has a specified gain, thereby providing users having network connectable devices located within a coverage area provided with a strong and reliable communication link with the base station. This may be particularly true in relation to millimetre wave 5G deployments, which may use narrow beams or directional beams to support communication with users to counteract high path loss and shadowing effects in electromagnetic wave propagation. It will be appreciated that a very focused or directional beam operates to concentrate the energy and ensure a reliable and strong communication link between communicating entities can be established. Such a focused beam can be obtained by careful placement, for example, of a reflector and feed. In particular, a feed may be placed a focal distance away from a reflector, so that the resulting beam is narrow. If the feed is slightly misplaced, a slightly wider unfocused beam may be generated, which can have advantages, up to the point that the energy in the broader beam is insufficient to counteract the high path loss and shadowing effects associated with mmW propagation. As a result, antenna apparatus which can provide strong gain can be particularly useful in supporting a millimetre wave 5G FWA base station deployment.

Before providing a detailed explanation of example embodiments, an analysis of standard operation of antenna apparatus is provided. FIG. 1 is a plot illustrating gain which can be achieved in antenna implementations comprising a feed and a parabolic main reflector. Four different antenna feed configurations are considered: (a) a single antenna feed patch; (b) a 1×4 feed array; (c) a 2×2 feed array; and (d) a 4×4 feed array. Gain achieved (y-axis) if the feed is used with parabolic reflectors having various decreasing curvatures (focal distance of parabolic main reflector—x-axis) is shown. It can be seen that, for a single feed (a), the gain which can be achieved decreases as the curvature of the main parabolic reflector decreases. Conversely, for a 4×4 array (d), the gain achieved can be increased by adjusting the curvature of the main parabolic reflector to capture a greater portion of the energy emanating from the larger array feed. In relation to the 1×4 feed (b), adjusting the curvature by gently reducing the curvature of the main parabolic reflector causes a small increase in achievable gain, but the maximum gain achieved reaches a peak much lower than might be needed to support FWA base station operation before tailing off as the parabolic reflector tends to a planar reflector. Example embodiments described recognise that the cause of smaller gain in relation to a 1×4 array (b) can be attributed to the nature of the radiation pattern from a 1×4 array. A radiation pattern from the 1×4 array, without a secondary feed reflector in accordance with example embodiments, is such that some energy in the radiation pattern is lost and/or not effectively transferred to a main parabolic reflector.

Example embodiments recognise that it is possible to improve gain achieved by antenna apparatus if a properly configured secondary reflector is provided close to a feed or feed array, to modify a radiation pattern which is fed to the main reflector.

FIG. 2 is a plot illustrating energy in a radiation pattern emanating from a 1×4 feed array without a dedicated feed reflector and with a dedicated feed reflector. The plot of FIG. 2 includes gain achieved from a 1×4 feed array in both horizontal (plots (i) and (ii)) and vertical ((iii) and (iv)) directions. The plots show the feed gain achieved without (plots (i) and (iii)) a feed reflector and when a 1×4 feed array is provided with a parabolic dedicated feed reflector (plots (ii) and (iv)). It can be seen that the energy in a resulting radiation pattern is greater and less spread when a feed reflector is introduced.

If a parabolic feed reflector is to be implemented, the feed array may be located optimally at, or very close to, the focal point of the parabolic feed reflector. Furthermore, if the feed array and feed reflector are to be used with a parabolic main reflector, the feed array may also be located optimally at, or very close to, the focal point of the main reflector. The main and feed reflectors may be located on opposite sides of a feed array. A main axis of radiation direction of the feed reflector and main reflector may be coincident, but opposite, to achieve a maximum gain.

Example embodiments offer the possibility, for a fixed main reflector focal distance and a fixed main reflector size or dimension, as may be the case when choosing components for a FWA base station, of achieving a better total gain compared to a case without a feed array reflector.

FIG. 3A illustrates schematically main components of an antenna apparatus including an arrangement according to one example embodiment. The antenna apparatus 100 of FIG. 3A comprises a 1×4 feed array 10 located at the focal point of a parabolic feed reflector 20. Radiation from the feed array 10 is reflected by the parabolic feed reflector 20 towards a main antenna reflector 30. Main antenna reflector comprises a parabolic reflector. The radiation pattern from the feed array 10 is improved by concentration of energy in the radiation pattern and mitigation of lost pattern at the feed array reflector 20 and the main reflector 30.

In particular, arrangements recognise that arranging feed array 10 such that it faces the main reflector 30 allows a main front lobe of a radiation pattern generated by the feed array 10 to be reflected. Providing a feed array reflector 20 which is arranged around and behind the feed array 10 can enable the reflection of any side or back lobes of a radiation pattern generated by the feed array 10 to be redirected towards the main reflector. The feed array 10 physically sits in between the main reflector and the feed array reflector. In other words, the feed array is located between the main reflector and the feed array reflector. Both the feed array 10 and the feed reflector are positioned such that radiation emanates from them towards the main reflector. In the example shown in FIG. 3A, the 1×4 feed array produces, in the transmission case, a radiation pattern having a main front lobe and various side and back lobes which emanating around the feed array. The feed array reflector 20 is positioned to reflect any side and/or back-lobes created by the feed array and is configured to reflect those side/back-lobe waves and energy contained therein back towards the main reflector 30. The feed array is configured to direct its main lobe directly, without reflection, towards the main reflector.

Appropriate arrangement of components 10, 20 and may also allow for the feed array and main reflector to be closer together than an arrangement in which no feed reflector 20 is provided, thereby allowing for a reduction in overall antenna apparatus 100 size. By way of an example, a mmW implementation of antenna apparatus 100 such as that shown in FIG. 3A allowed for reduction of “thickness” of the apparatus from ˜130 mm to ˜80 mm whilst also achieving an improvement in antenna gain to a level suited to use of the antenna apparatus 100 in a FWA base station deployment.

FIG. 3B is 3-dimensional plot of gain achieved by an antenna apparatus such as that shown in FIG. 3A. FIG. 3C is a plot of the horizontal (ii) and vertical (iv) gain achieved by an antenna apparatus including a feed reflector such as that shown in FIG. 3A.

Some example embodiments recognise that it is possible to integrate a feed reflector into a feed support structure. Antenna apparatus including main components arranged generally as shown schematically in FIG. 3A are typically secured in position with respect to one another by appropriate support structures and housings. An antenna feed, such as that shown in FIG. 3A will typically be housed or supported with components such as electronics and a heat sink. The feed array support structure or housing may be configured to hold a feed array in position with respect to a main reflector. Some example embodiments recognise that it is possible to integrate the feed reflector into a feed array support structure.

FIG. 4A illustrates some main components housed in and around a feed array support structure. Feed array support structure 200 comprises two support arms 210 configured for attachment to other components of an antenna apparatus. The support structure 200 further comprises a feed array 220. The feed array in the example shown in FIG. 4A comprises a 1×4 feed array. The feed array 220 is mounted on a support plate 230, and is coupled to a heat sink 240. The feed array is protected by a protective front plate 250 which includes an opening or hole 260 dimensioned to allow access to the feed array 220. The front plate 250 typically comprises a plastic front plate and acts to protect the feed array from mechanical interference or damage during assembly of an antenna apparatus and during antenna apparatus operation.

FIG. 4B is a plot of signal gain from an arrangement such as that shown in FIG. 4A. In particular, FIG. 4B illustrates gain plots which may be obtained: (a) without front plate 250; (b) with plastic front plate 250, when opening 260 has abrupt rectangular edges likely to cause diffraction of a radiation pattern emanating from feed array 220; (c) with plastic front plate 250, when opening 260 has smoothed edges, taking the form of part of a parabolic curve; and (d) with plastic front plate 250, when opening 260 has smoothed edges, and supports a metallized insert taking the form of part of a parabolic curve as shown in more detail in FIG. 5. It can be seen that the arrangement which results in gain plot (d) results in the smoothest gain curve emanating from the feed array and the greatest absolute gain from feed array 220.

FIG. 5 illustrates some main components housed in and around a feed array support structure including a feed reflector according to one possible example embodiment. As described above in relation to FIG. 4A, a feed array support structure 300 comprises two support arms 310 configured for attachment to other components of an antenna apparatus. The support structure 300 further comprises a feed array 320. The feed array in the example shown in FIG. 5 comprises a 1×4 feed array. The feed array 320 is mounted on a support plate 330, and is coupled to a heat sink 340. The feed array is protected by a protective front plate 350 which includes an opening or hole 360 dimensioned to allow access to the feed array 320. The arrangement of FIG. 5 further comprises a feed reflector 370 comprising a metallized insert taking the form of part of a parabolic curve. The feed reflector 370; support plate 330, feed array 320 and front plate 350 are dimensioned and located with respect to each other such that the feed array 320 is positioned at, or approximately at, the parabolic curve focal distance of parabolic feed reflector 370.

Example embodiments such as that illustrated in FIG. 5 may exhibit benefits as a result of provision of a feed reflector as part of the mechanical structure of a feed array support. For example, FIG. 4B illustrates how use of a metallized parabolic feed reflector may help to mitigate issues in a radiation pattern emanating from a feed array which can result from a standard support, such as diffraction issues, whilst also preserving total gain.

FIG. 6 illustrates some components of a feed array support including a feed reflector according to one example embodiment. In the example embodiment of FIG. 6, a feed array 410 is provided with a parabolic feed reflector 420. The feed array 410 is also provided with a heat sink 430. The heat sink can take any format behind the feed reflector 420, since the feed reflector shown in FIG. 6 shields the sink from radiation emanating from feed array 410. As a precaution against diffraction effects, the heat sink 4 can be formed to include only smooth corners. A feed array structure such as that shown in FIG. 5 or FIG. 6 may be such that the impact of the support structure on total antenna apparatus gain is negligible even when the significant mechanical intrusion of the feed support structure is located, for example, in the middle of the main parabolic reflector of an antenna apparatus.

FIG. 7 illustrates some components of an antenna device according to one possible alternative example embodiment. In the example of FIG. 7, a feed array 710 can be provided with a feed reflector, for example, a parabolic feed reflector (not shown). The feed array 710 is configured to pass a signal to be transmitted onwards to a transmit array 720. The example embodiment illustrated in FIG. 7 recognises that the larger or “main” reflector of an antenna device such as the example shown in FIG. 3A may be replaced by something other than a standard reflector. In FIG. 7 the feed array and feed reflector are configured to pass a signal to a transmit array which acts as a type of lens. The transmit array in FIG. 7 is configured to transmit main radiation in a general direction indicated area 730. It will be appreciated that a radio frequency antenna lens operates to accept radiation from an antenna feed array and modify a received radiation pattern shape when the radiation passes through the lens, for example, by means of refraction. A reflector, such as that shown in FIG. 3A, may also be configured to change the shape of an incident radiation pattern but may also simply redirect the incident radiation pattern. The main transmission portion of an antenna device, be it reflector or lens, may operate to redirect radio waves and/or reshape radio waves and radiation patterns. It will be appreciated that the “concentration” of energy emanating from a feed array by provision of a feed reflector, as shown in FIG. 2 may be equally useful in relation to use with a transmission portion of an antenna device whether a reflector or a lens.

As used in this application, the term “circuitry” may refer to one or more or all of the following:

(a) hardware-only circuit implementations (such as implementations in only analog and/or digital circuitry) and
(b) combinations of hardware circuits and software, such as (as applicable):
(i) a combination of analog and/or digital hardware circuit(s) with software/firmware and
(ii) any portions of hardware processor(s) with software (including digital signal processor(s)), software, and memory(ies) that work together to cause an apparatus, such as a mobile phone or server, to perform various functions) and
   (c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

Although embodiments of the present invention have been described in the preceding paragraphs with reference to various examples, it should be appreciated that modifications to the examples given can be made without departing from the scope of the invention as claimed.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. An apparatus, comprising:
an antenna feed array;
a main antenna reflector or lens; and
a feed reflector;
wherein the feed reflector comprises a concave reflective surface configured to reflect radio-frequency radiation from the antenna feed array towards the main antenna reflector or lens and dimensioned to adjust radio-frequency radiation transmittable from the antenna feed array to the main antenna reflector or lens via the feed reflector by narrowing the spread of the radio-frequency radiation reflected by the feed reflector towards the main antenna reflector or lens.

2. An apparatus according to claim 1, wherein the feed reflector has a curvature greater than the main antenna reflector or lens.

3. An apparatus according to claim 1, wherein the feed reflector comprises a parabolic reflector.

4. An apparatus according to claim 3, wherein the antenna feed array is located substantially at the focal point of the parabolic feed reflector.

5. An apparatus according to claim 1, wherein the main antenna reflector comprises a parabolic reflector.

6. An apparatus according to claim 5, wherein the antenna feed array is located substantially at the focal point of the main parabolic reflector.

7. An apparatus according to claim 1, wherein the feed reflector and main antenna reflector have a common radiation directional axis.

8. An apparatus according to claim 1, wherein the feed reflector and main antenna reflector are located on diametrically opposed sides of the antenna feed array.

9. An apparatus according to claim 1, wherein the apparatus comprises a feed support structure configured to support the antenna feed array in position relative to the main antenna reflector or lens and wherein the feed reflector forms part of the feed support structure.

10. An apparatus according to claim 9, wherein the feed reflector is integrally formed as part of the feed support structure.

11. An apparatus according to claim 1, wherein the antenna feed array comprises a longitudinal array formed from a plurality of patch antenna feed elements.

12. An apparatus according to claim 1, wherein the apparatus is dimensioned to support radio-frequency radiation which comprises millimetre wave radiation.

13. An electronic device comprising the apparatus according to claim 1.

14. An electronic device according to claim 13 comprising a fixed wireless access base station for use in a millimetre wave radio communication network.

15. A method, comprising:
providing an antenna feed array; a main antenna reflector or lens; and a feed reflector; and
configuring a concave reflective surface of the feed reflector to reflect radio-frequency radiation from the antenna feed array towards the main antenna reflector or lens, the concave reflective surface being dimensioned to adjust radio-frequency radiation transmittable from the antenna feed array to the main antenna reflector or lens via the feed reflector by narrowing the spread of the radio-frequency radiation reflected by the feed reflector towards the main antenna reflector or lens.

16. A method according to claim 15, wherein providing the feed reflector comprises providing the feed reflector having a curvature greater than the main antenna reflector or lens.

17. A method according to claim 15, wherein providing the feed reflector comprises providing a parabolic reflector.

18. A method according to claim 15, wherein providing the main antenna reflector comprises providing a parabolic reflector.

19. A method according to claim 15, wherein providing the main antenna reflector and the feed reflector comprises providing the feed reflector and main antenna reflector so as to have a common radiation directional axis.

20. A method according to claim 15, wherein providing the main antenna reflector and the feed reflector comprises providing the feed reflector and main antenna reflector so as to be located on diametrically opposed sides of the antenna feed array.
